(19) United States
(12) Patent Application Publication
(10) Pub. No.: US 2024/0379023 A1
(43) Pub. Date: Nov. 14, 2024

(54) INFORMATION PROCESSING APPARATUS, INCENTIVE PLAN CALCULATION METHOD AND PROGRAM

(71) Applicant: NIPPON TELEGRAPH AND TELEPHONE CORPORATION, Tokyo (JP)

(72) Inventors: Yuka NISHIDA, Tokyo (JP); Hideaki KIN, Tokyo (JP); Takeshi KURASHIMA, Tokyo (JP); Hiroyuki TODA, Tokyo (JP)

(21) Appl. No.: 18/291,750

(22) PCT Filed: Sep. 17, 2021
(86) PCT No.: PCT/JP2021/034346

§ 371 Date: Jan. 24, 2024

(51) Int. Cl. G09B 19/00

(52) U.S. Cl. CPC G09B 19/00

(57) ABSTRACT

An information processing apparatus includes a data acquisition unit that acquires data indicating a relationship between success or failure of a task and an amount of a loss-framed incentive indicating an incentive that is forfeited in a case where the task is not successful, and information indicating a motivation function representing motivation of a user for the task, a parameter determination unit that determines a parameter of the motivation function based on the data, and an incentive measure calculation unit that calculates an incentive measure indicating an amount of a loss-framed incentive based on the determined parameter and the motivation function.

### TECHNICAL FIELD

The present invention relates to an information processing apparatus, an incentive measure calculation method, and a program.

### BACKGROUND ART

Although there are matters to be continuously performed such as healthy actions or learning actions, people have difficulty in voluntarily continuing the matters in some cases. Maintaining motivation for these actions at a high level in order to continue the actions is necessary for people to live better lives.

For example, in Non-Patent Literature 1, an experiment of encouraging a healthy action using a monetary incentive is performed, and the experiment performed with the following three designed as an incentive is disclosed.
Gain-framed incentive: In a case where the goal is achieved, a fixed amount of an incentive is given each time. In a case where the goal is not achieved, there is no incentive.
Lottery incentive: In a case where the goal is achieved, an amount of an incentive is decided and given by way of a lottery. In a case where the goal is not achieved, there is no incentive.
Loss-framed incentive: In a case where the goal is achieved, an incentive given in advance is maintained. In a case where the goal is not achieved, a fixed amount of an incentive is forfeited each time.
   As a result, it was found that the loss-framed incentive had the highest effect of promoting a healthy action.

Non-Patent Literature 2 discloses that a goal of exercise is set every day for a heart disease patient wearing a wearable device, and in a case where the goal can be achieved, a monetary incentive given in advance is maintained, and in a case where the goal cannot be achieved, a fixed amount of an incentive is forfeited every time (intervention by the loss-framed incentive), thereby promoting to habituate exercise. By the loss-framed incentive being utilized, the following four psychological effects can be incorporated.
Loss is valued over gain according to the Prospect theory.
Immediate satisfaction is prioritized over delayed satisfaction by the present bias.
Regret is avoided.
Efforts are particularly made near a landmark, such as at the beginning of a week.

### CITATION LIST

### Non-Patent Literature

Non-Patent Literature 1: Mitesh S. Patel et al., “Framing Financial Incentives to Increase Physical Activity Among Overweight and Obese Adults”, Annals of Internal Medicine, Vol. 164, issue 6, p. 385-394, Mar. 15, 2016
Non-Patent Literature 2: Neel P. Chokshi et al., “Loss-Framed Financial Incentives and Personalized Goal-Setting to Increase Physical Activity Among Ischemic Heart Disease Patients Using Wearable Devices: The ACTIVE REWARD Randomized Trial”, Journal of the American Heart Association, Vol. 7, No. 12, Jun. 9, 2018
Non-Patent Literature 3: Marc S Mitchell et al., “Financial incentives for physical activity in adults: systematic review and meta-analysis”, British Journal of Sports Medicine, Vol. 54, Issue 21, May 15, 2019

### SUMMARY OF INVENTION

### Technical Problem

In any of Non-Patent Literature 1 to 3, it is described that a success rate of a task is increased in a case where the loss-framed incentive is used. However, there is no description that a success rate of a task is the highest in a case where the amount of the loss-framed incentive is a fixed amount every time, and an amount of the loss-framed incentive that maximizes the success rate of a task has not yet been determined.

An object of the disclosed technology is to calculate an incentive measure that increases a success rate of a task.

### Solution to Problem

The disclosed technology is an information processing apparatus including a data acquisition unit that acquires data indicating a relationship between success or failure of a task and an amount of a loss-framed incentive indicating an incentive that is forfeited in a case where the task is not successful, and information indicating a motivation function representing motivation of a user for the task, a parameter determination unit that determines a parameter of the motivation function based on the data, and an incentive measure calculation unit that calculates an incentive measure indicating an amount of a loss-framed incentive, based on the determined parameter and the motivation function.

### Advantageous Effects of Invention

An incentive measure that increases a success rate of a task can be calculated.

### BRIEF DESCRIPTION OF DRAWINGS

FIG. 1 is a diagram illustrating a functional configuration example of an information processing device.

FIG. 2 is a flowchart illustrating an example of a flow of loss-framed incentive measure calculation processing.

FIG. 3 is a diagram illustrating a hardware configuration example of a computer.

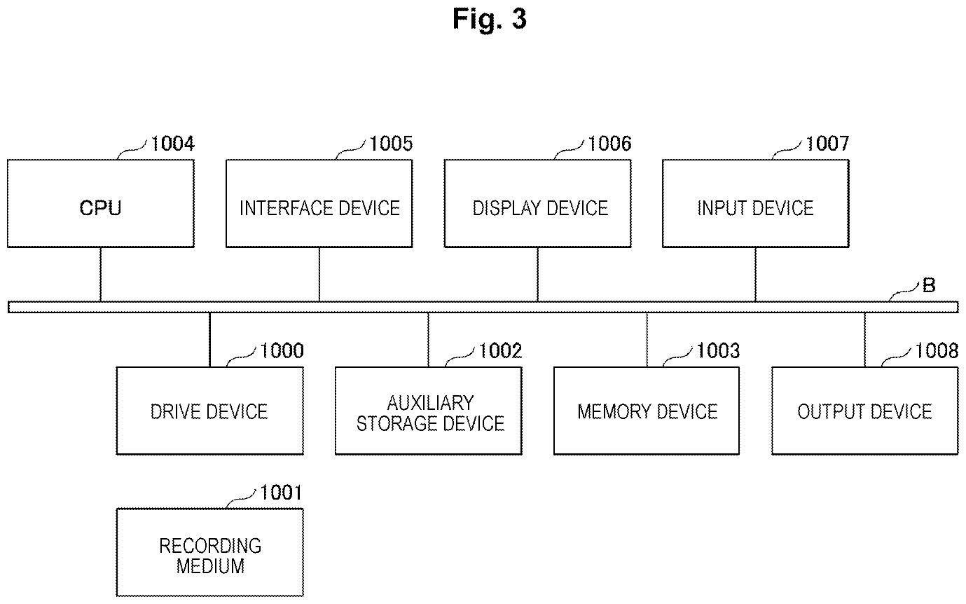

### DESCRIPTION OF EMBODIMENTS

Hereinafter, an embodiment of the present invention (present embodiment) will be described with reference to the drawings. The embodiment described below is merely an example, and embodiments to which the present invention is applied are not limited to the embodiment described below.

### Outline of Present Embodiment

An information processing device (information processing apparatus) according to the present embodiment acquires experimental data and motivation function information, determines parameters of a motivation function, and calculates a loss-framed incentive measure that increases a success rate of a task.

### (Functional Configuration Example of Information Processing Device)

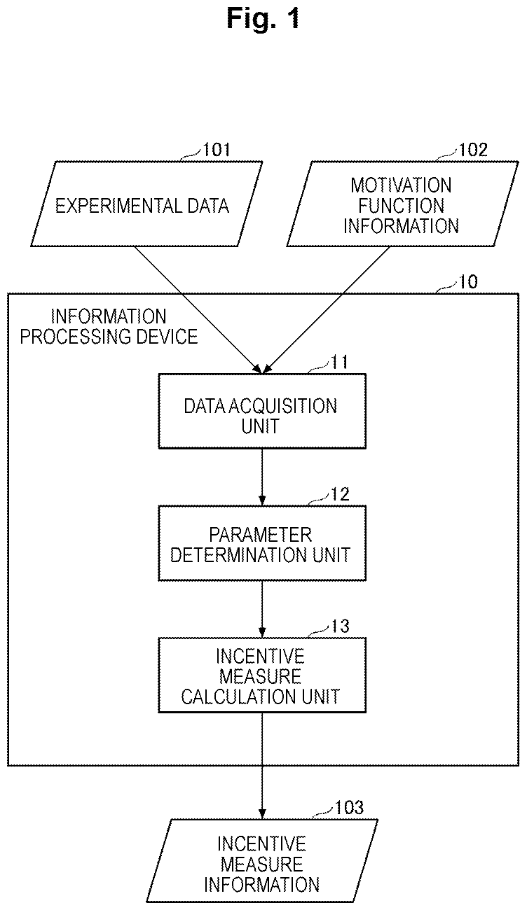

FIG. 1 is a diagram illustrating a functional configuration example of an information processing device (information processing apparatus). An information processing device 10 (information processing apparatus) includes a data acquisition unit 11, a parameter determination unit 12, and an incentive measure calculation unit 13.

The data acquisition unit 11 acquires experimental data 101 and motivation function information 102.

The experimental data 101 is data indicating a result of performing an experiment in which one or a plurality of users are caused to perform a task with intervention by a loss-framed incentive performed. For example, the content of the experiment is as follows.

Each of the users is given p₀ as a temporary acquisition incentive on the first day of an experimental period T. The temporary acquisition incentive is an incentive that each of the users temporarily acquires, and is an incentive that the users can definitely acquire by success of the task. Every day, before the success or failure of the task is determined, declaration of “the temporary acquisition incentive is maintained at pₜ₋₁ in a case where the task on the t-th day succeeds, and an incentive of xₜ is forfeited from pₜ₋₁ in a case where it fails” is made. The loss-framed incentive xₜ presented at this time is a value randomly selected from a set X. Provided that 0<xₜ<pₜ₋₁,

$${p}_{t - 1} = {p}_{0} - {\sum }_{\begin{matrix}t IN CASE \\ OF FAILURE\end{matrix}} {x}_{ι} \qquad [ Math . 1 ]$$

the above formula is satisfied.

The experimental data 101 is data obtained from the above-described experiment, and includes, for example, loss-framed incentives xₜ, . . . , x_{T} presented in each step of each of the users, temporary acquisition incentives p₁, . . . , p_{T}, and information of the success or failure of the task (yₜ=(1, 0)) y₁, . . . , y_{T}. Note that the experimental data 101 may be data obtained from theory, inference, or the like as long as the data indicates a relationship between the amount of a loss-framed incentive and the success or failure of the task.

The motivation function information 102 is information indicating a function indicating motivation of a user for the task (hereinafter, referred to as motivation function). The motivation function is expressed as follows, for example, using a success probability of the task in each step t of each of the users as uₜ.

$${u}_{t} = ( term of loss - framed incentive presented ) + ( term of temporary acquisition incentive )$$

### (Term of Loss-Framed Incentive Presented)

The term of a loss-framed incentive presented satisfies the following conditions.

(1) As a loss-framed incentive presented increases, motivation also increases.

(2) There is a decreasing marginal utility property.

(3) In a case where a loss-framed incentive presented exceeds a certain threshold, motivation increases drastically.

(4) Normalization is performed.

### (Term of Temporary Acquisition Incentive)

The term of a temporary acquisition incentive satisfies the following conditions.

(1) As a temporary acquisition incentive increases, motivation also increases.

(2) There is a decreasing marginal utility property.

(3) In a case where a temporary acquisition incentive exceeds a certain threshold, motivation increases drastically.

(4) Normalization is performed.

As an example of satisfying (1) and (2) in each term, power functions x^{α}ₜ, p^{β}ₜ₋₁ may be used. Here, 0<α<1,0<β<1 are satisfied. As an example of satisfying (3) in each term, a sigmoid function of the following formula may be used using a gain in the term of a loss-framed incentive presented or the term of a temporary acquisition incentive as a or b.

$${σ}_{a} ( x ) = \frac{1}{1 + {e}^{- ax}} , {σ}_{b} ( x ) = \frac{1}{1 + {e}^{- b x}} \qquad [ Math . 2 ]$$

As an example of satisfying (4) in each term, a min function may be used.

That is, an example of the motivation function uₜ is expressed as follows.

$${u}_{t} = A min ( {x}_{t}^{α} {σ}_{a} ( {x}_{t} - {x}_{loss} ) , 1 ) + B min ( {p}_{t - 1}^{β} {σ}_{b} ( {p}_{t - 1} - {p}_{t e m p} ) , 1 ) \qquad [ Math . 3 ]$$

Provided that A, B, α, β, a, b, xₗₒₛₛ, and pₜₑₘₚ represent user-specific parameters. Since A and B represent the ratio of the influence of a loss-framed incentive presented and a temporary acquisition incentive, A, B>0 and A+B=1 are satisfied. Note that, since the influence of a temporary acquisition incentive is weak and the influence of a loss-framed incentive presented is strong for a user for which A>B is satisfied, the user is a person who makes greater effort for task success by a loss-framed incentive presented being increased or decreased. Since the influence of a temporary acquisition incentive is strong for a user for which A<B is satisfied, the user is a person who does not make efforts for task success even if a loss-framed incentive presented is increased or decreased any amount in a case where the task fails and the temporary acquisition incentive decreases below a certain threshold.

xₗₒₛₛ and pₜₑₘₚ represent thresholds at which motivation drastically increases.

The advantage of defining the motivation function in this manner is that a magnitude relationship of the influence of a loss-framed incentive presented and a temporary acquisition incentive can be clarified and the personality can be made clear.

The parameter determination unit 12 determines eight parameters included in the motivation function based on the experimental data 101 and the motivation function information 102.

The parameter determination unit 12 uses a loss-framed incentive presented in each step, a temporary acquisition incentive, and the success or failure of the task (yₜ=(1, 0)) as observation values based on the experimental data 101. That is, the observation values are (x₁, p₀, y₁), . . . , (x_{T}, p_{T-1}, y_{T}).

A probability model indicating the probability of the success or failure in the task in each step is expressed by a binomial distribution as in the following formula.

$$P ( {y}_{t} \vert {u}_{t} ) = {{u}_{t}^{{y}_{t}} ( 1 - {u}_{t} )}^{1 - {y}_{t}} \qquad [ Math . 4 ]$$

Here, P(yₜ|uₜ)=P(yₜ|uₜ(s) is satisfied. s represents the user-specific parameters A, B, α, β, a, b, xₗₒₛₛ, and pₜₑₘₚ.

Likelihood L(s) in the probability model is expressed as following formula.

$$L ( s ) = P ( {y}_{1} \vert {u}_{1} ( s ) ) \times … \times P ( {y}_{T} \vert {u}_{T} ( s ) ) \qquad [ Math . 5 ]$$

The parameter determination unit 12 determines each of the parameters using maximum likelihood estimation as indicated in the following formula.

$${s}^{*} = arg {max}_{s} L ( s ) \qquad [ Math . 6 ]$$

An example of the parameters to be determined is as follows.

TABLE 1

| A | B | α | β | a | b | xₗₒₛₛ | pₜₑₘₚ |
|---|---|---|---|---|---|---|---|
| 0.4 | 0.6 | 0.5 | 0.2 | 10 | 8 | 100 | 500 |

The incentive measure calculation unit 13 calculates an incentive measure that increases motivation of a user. For example, the incentive measure calculation unit 13 optimizes the amount of a loss-framed incentive that maximizes motivation of a user, and calculates the loss-framed incentive at that time.

Specifically, the incentive measure calculation unit 13 calculates an incentive measure based on the motivation function information 102 and the determined parameters. The incentive measure is a function ƒ that uses the task success/failure yₜ₋₁ on the (t−1)-th day, the temporary acquisition incentive pₜ₋₁, and the current time step t as inputs and outputs the loss-framed incentive amount xₜ on the t-th day as indicated in the following formula.

$${x}_{t} = f ( t , {y}_{t - i} , {p}_{t - 1} ) \qquad [ Math . 7 ]$$

The optimum incentive measure is a measure that maximizes the expected value of the total number of times of task success in T days as indicated in Formula (1).

$$\begin{matrix}[ Math . 8 ] & \\ {f}^{*} = arg {max}_{f} E [ {\sum }_{t = 1}^{T} {y}_{t} ] & ( 1 )\end{matrix}$$

Here, E[·] represents an expected value.

Under the above-described motivation function, the success or failure yₜ of the task follows the following Markov decision process (hereinafter, referred to as MDP).

State on the t-Th Day:

$${V}_{t} = ( t , {y}_{t - 1} , {p}_{t - 1} ) \qquad [ Math . 9 ]$$

Incentive Set that can be Taken on the t-Th Day:

$$\begin{matrix}{𝒳}_{t} = \{ x ∈ 𝒳 \vert x \leq {p}_{t - 1} \} , & 𝒳 = \{ {a}_{1} , {a}_{2} , … , {a}_{N} \}\end{matrix} \qquad [ Math . 10 ]$$

Probability that the state Vₜ₊₁=(t+1, yₜ, pₜ) on the (t+1)-th day is generated under conditions of the state on the t-th day and an incentive:

$$\begin{matrix}\begin{matrix}P ( {y}_{t} \vert {V}_{t} , {x}_{t} ) = {{u}_{t}^{{y}_{t}} ( 1 - {u}_{t} )}^{1 - {y}_{t}} , & {u}_{t} = {u}_{t} ( {V}_{t} , {x}_{t} )\end{matrix} \\ {p}_{t} = {p}_{t - 1} - ( 1 - {y}_{t} ) {x}_{t}\end{matrix} \qquad [ Math . 11 ]$$

Reward of the t-Th Day t: yₜ

Provided that a possible value of the loss-framed incentive xₜ is equal to or less than the temporary acquisition incentive pₜ₋₁ among N discrete values {a₁, a₂, . . . , a_{N}} prepared in advance. It is known that, in the MDP, a measure that maximizes the expected value of the reward sum expressed as follows is obtained by the Bellman optimality equation being solved.

$$E [ {\sum }_{t = 1}^{T} {y}_{t} ] \qquad [ Math . 12 ]$$

Therefore, the incentive measure calculation unit 13 obtains a measure f* that satisfies Formula (1) by similarly solving the Bellman optimality equation. There is a plurality of methods for solving the Bellman optimality equation, and as an example, Deep Q Network using a neural network can be cited (Reference Literature 1).

The incentive measure calculation unit 13 outputs incentive measure information 103 indicating the calculated incentive measure f*. For example, in a case where Deep Q Network is used, f* can be given by following formula using an action value function Q(Vₜ, xₜ) approximated by a neural network.

$${f}^{*} = arg {max}_{{x}_{t} ∈ {𝒳}_{t}} Q ( {V}_{t} , {x}_{t} ) \qquad [ Math . 13 ]$$

In this case, the output incentive measure information 103 is a model parameter group of the neural network.

### (Operation Example of Information Processing Device)

Next, an operation example of the information processing device 10 will be described with reference to the drawings. The information processing device 10 starts incentive measure calculation processing in response to a user's operation or the like.

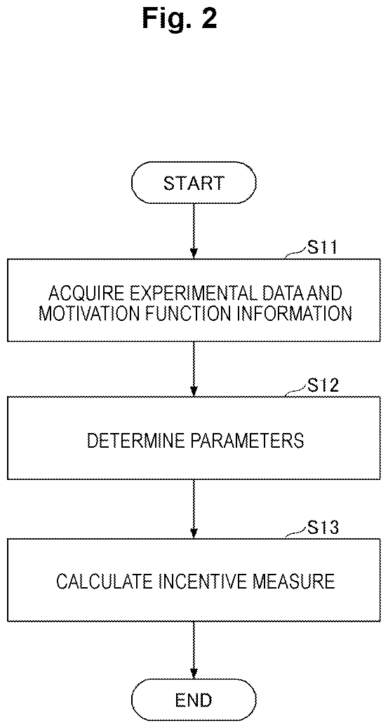

FIG. 2 is a flowchart illustrating an example of a flow of incentive measure calculation processing. The data acquisition unit 11 receives an input or the like from a user to acquire the experimental data 101 and the motivation function information 102 (step S11).

The parameter determination unit 12 determines the parameters based on the experimental data 101 and the motivation function information 102 (step S12).

The incentive measure calculation unit 13 calculates an incentive measure based on the motivation function information 102 and the determined parameters (step S13). The incentive measure calculation unit 13 outputs the incentive measure information 103 indicating the calculated incentive measure.

### (Hardware Configuration Example According to Present Embodiment)

The information processing device 10 can be implemented, for example, by a computer being caused to execute a program in which processing content described in the present embodiment is described. Note that the “computer” may be a physical machine or may be a virtual machine in a cloud. In a case where a virtual machine is used, “hardware” described herein is virtual hardware.

The program can be stored and distributed by being recorded in a computer-readable recording medium (portable memory or the like). The program can also be provided through a network such as the Internet or an electronic mail.

FIG. 4 is a diagram illustrating a hardware configuration example of the computer. The computer in FIG. 4 includes a drive device 1000, an auxiliary storage device 1002, a memory device 1003, a CPU 1004, an interface device 1005, a display device 1006, an input device 1007, an output device 1008, and the like, which are connected to each other by a bus B.

The program for implementing processing in the computer is provided through a recording medium 1001 such as a CD-ROM or a memory card, for example. When the recording medium 1001 that stores the program is set in the drive device 1000, the program is installed from the recording medium 1001 into the auxiliary storage device 1002 via the drive device 1000. However, the program is not necessarily installed from the recording medium 1001 and may be downloaded from another computer via a network. The auxiliary storage device 1002 stores the installed program and also stores necessary files, data, and the like.

In a case where an instruction to start the program is issued, the memory device 1003 reads the program from the auxiliary storage device 1002, and stores the program therein. The CPU 1004 implements a function related to the device in accordance with the program stored in the memory device 1003. The interface device 1005 is used as an interface for connection to the network. The display device 1006 displays a graphical user interface (GUI) or the like according to the program. The input device 1007 includes a keyboard and a mouse, buttons, a touch panel, or the like, and is used to input various operation instructions. The output device 1008 outputs a computation result. Note that the computer may include a graphics processing unit (GPU) or a tensor processing unit (TPU) instead of the CPU 1004, and may include a GPU or a TPU in addition to the CPU 1004. In such a case, for example, processing may be shared and executed such that the GPU or the TPU executes processing requiring special computation and the CPU 1004 executes other processing.

### REFERENCE LITERATURE

Reference Literature 1: Volodymyr Mnih et al., “Playing Atari with Deep Reinforcement Learning”, arkiv, 2013

### Effects of Present Embodiment

According to the information processing device 10 according to the present embodiment, experimental data 101 and motivation function information 102 are acquired, parameters of a motivation function is determined, and a loss-framed incentive measure that increases a success rate of a task is calculated. As a result, an incentive measure that increases a success rate of a task can be calculated.

The information processing device 10 may calculate the amount of a loss-framed incentive that maximizes the average motivation in a period in which a task is executed. As a result, the task success rate can be further increased.

The information processing device 10 may input output incentive measure information 103 to a design device that performs task design and the like. The design device can design a task indicating a high success rate based on the input incentive measure information 103.

### Summary of Embodiment

In the present specification, at least the information processing device (information processing apparatus), the incentive measure calculation method, and the program described in items described below are described.

### (Item 1)

An information processing device (information processing apparatus) including:
a data acquisition unit that acquires data indicating a relationship between success or failure of a task and an amount of a loss-framed incentive indicating an incentive that is forfeited in a case where the task is not successful, and information indicating a motivation function representing motivation of a user for the task;
a parameter determination unit that determines a parameter of the motivation function based on the data; and
an incentive measure calculation unit that calculates an incentive measure indicating an amount of a loss-framed incentive, based on the determined parameter and the motivation function.

### (Item 2)

The information processing device according to the item 1,
in which the motivation function includes a term of a loss-framed incentive presented and a term of a temporary acquisition incentive, and each term includes a power function, a sigmoid function, or a min function.

### (Item 3)

The information processing device according to the item 1 or 2,
in which the parameter determination unit estimates likelihood of a probability model in which the task is successful by maximum likelihood estimation and determines the parameter.

### (Item 4)

The information processing device according to any one of items 1 to 3,
in which the incentive measure calculation unit calculates the incentive measure by solving a Bellman optimality equation so as to maximize an expected value of a reward sum in a Markov decision process, assuming that success or failure of a task follows the Markov decision process.

### (Item 5)

An incentive measure calculation method performed by an information processing device, including:
a step of acquiring data indicating a relationship between success or failure of a task and an amount of a loss-framed incentive indicating an incentive that is forfeited in a case where the task is not successful, and information indicating a motivation function representing motivation of a user for the task;
a step of determining a parameter of the motivation function based on the data; and
a step of calculating an incentive measure indicating an amount of a loss-framed incentive, based on the determined parameter and the motivation function.

### (Item 6)

A program for causing a computer to function as each unit in the information processing device according to any one of items 1 to 4.

Although the present embodiment has been described so far, the present invention is not limited to such a specific embodiment, and various modifications and changes can be made within the scope of the present invention disclosed in the claims.

### REFERENCE SIGNS LIST

10 Information processing device
11 Data acquisition unit
12 Parameter determination unit
13 Incentive measure calculation unit
101 Experimental data
102 Motivation function information
103 Incentive measure information
1000 Drive device
1001 Recording medium
1002 Auxiliary storage device
1003 Memory device
1004 CPU
1005 Interface device
1006 Display device
1007 Input device
1008 Output device

1. An information processing apparatus comprising:
a processor; and
a memory that includes instructions, which when executed, cause the processor to execute a method, said method including:
acquiring data indicating a relationship between success or failure of a task and an amount of a loss-framed incentive indicating an incentive that is forfeited in a case where the task is not successful, and information indicating a motivation function representing motivation of a user for the task;
determining a parameter of the motivation function based on the data; and
calculating an incentive measure indicating an amount of a loss-framed incentive, based on the determined parameter and the motivation function.

2. The information processing apparatus according to claim 1,
wherein the motivation function includes a term of a loss-framed incentive presented and a term of a temporary acquisition incentive, and each term includes a power function, a sigmoid function, or a min function.

3. The information processing apparatus according to claim 1,
wherein the determining includes estimating likelihood of a probability model in which the task is successful by maximum likelihood estimation and determining the parameter.

4. The information processing apparatus according to claim 1,
wherein the calculating includes calculating the incentive measure by solving a Bellman optimality equation so as to maximize an expected value of a reward sum in a Markov decision process, assuming that success or failure of a task follows the Markov decision process.

5. An incentive measure calculation method performed by an information processing apparatus, the incentive measure calculation method comprising:
acquiring data indicating a relationship between success or failure of a task and an amount of a loss-framed incentive indicating an incentive that is forfeited in a case where the task is not successful, and information indicating a motivation function representing motivation of a user for the task;
determining a parameter of the motivation function based on the data; and
calculating an incentive measure indicating an amount of a loss-framed incentive, based on the determined parameter and the motivation function.

6. A non-transitory computer-readable medium having computer-readable instructions stored thereon which when executed cause a computer including a memory and a processor to execute the method executed by the processor in the information processing apparatus according to claim 1.
